(19) United States
(12) Patent Application Publication
(10) Pub. No.: US 2015/0324025 A1
(43) Pub. Date: Nov. 12, 2015

(54) USER INPUT DEVICE AND METHOD THEREOF

(71) Applicant: ELECTRONICS AND TELECOMMUNICATIONS RESEARCH INSTITUTE, Daejeon (KR)

(72) Inventors: Hee-Sook SHIN, Daejeon (KR); Min-Kyu KIM, Daejeon (KR); Chang-Mok OH, Daejeon (KR); Jong-Uk LEE, Daejeon (KR); Jeong-Mook LIM, Daejeon (KR); Hyun-Tae JEONG, Daejeon (KR)

(73) Assignee: ELECTRONICS AND TELECOMMUNICATIONS RESEARCH INSTITUTE, Daejeon (KR)

(21) Appl. No.: 14/674,925

(22) Filed: Mar. 31, 2015

(30) Foreign Application Priority Data
May 12, 2014 (KR) 10-2014-0056349

(51) Int. Cl. G06F 3/041; G06F 3/0488; G06F 3/01

(52) U.S. Cl. CPC G06F 3/041; G06F 3/017; G06F 3/04883

(57) ABSTRACT

A user input device and method thereof is provided. The user input device according to the present invention comprises a touch input module outputting a touch coordinate according to a touch input when there is the touch input on a touch screen region; a gesture input module outputting a gesture coordinate according to a gesture input when there is the gesture input on a predetermined spatial region corresponding to the touch screen; and a spatial convergence module adjusting at least one of the touch coordinate and the gesture coordinate based on a reference coordinate for a predetermined space by determining if the touch input and the gesture input are consecutive inputs based on the touch coordinate and the gesture coordinate.

### CROSS REFERENCE TO RELATED APPLICATION

This application claims the benefit of Korean Patent Application No. 10-2014-0056349, filed on May 12, 2014, entitled “System and Method for Decentralized Energy Resource based Active Virtual Power Energy Management”, which is hereby incorporated by reference in its entirety into this application.

### BACKGROUND OF THE INVENTION

1. Technical Field

The present invention relates to a user input device and method thereof and more particularly, to a user input device and method thereof using touch inputs on a 2D plate and gesture inputs on a 3D space.

2. Description of the Related Art

A user input technology can be classified into a touch input technology on a 2D plate and a gesture input technology on a 3D space. The touch input technology utilizes user inputs by recognizing not only single point touches but also multi-point and touch gestures, etc. and tries to define and recognize various touch gestures to deal with 3D contents.

In addition, a technology supporting user inputs with gestures and poses on a spatial region without contacting on the surface of a terminal to control 3D contents on a 3D space has been also introduced.

It can control 2D and 3D contents based on spatial gestures in large screen and remote user environments or can be applied to games, interfaces for smart TVs and the like. Particularly, in case of 3D gesture input, many technologies to recognize a touched point with a virtual object and represent virtual touch in a 3D input space have been also discussed.

In case of such a 2D touch input technology, it allows more reliable recognition and more accurate user input, compared to the 3D gesture recognition technology but it has limitations in touch recognition regions and touch operations, so that it causes user input region limitation and it requires to touch a specific region.

In case of 3D spatial input, it allows a larger user input region but it has difficulties to recognize and represent contact points with a certain virtual object in an aspect of recognition accuracy.

### SUMMARY OF THE INVENTION

The present invention is to resolve the problems associated with the conventional technologies and an aspect of the present invention is thus to provide a user input device and method thereof which is able to recognize touch inputs on a 2D plate and gesture inputs on a 3D space as a user input in one continuous space.

However, it is to be appreciated that the aspect of the present invention is not limited by the above mentioned description and other aspects which are not described will become more apparent to those of ordinary skill in the art by the description below.

A user input device according to an embodiment of the present invention may include a touch input module outputting a touch coordinate according to a touch input when there is the touch input on a touch screen region; a gesture input module outputting a gesture coordinate according to a gesture input when there is the gesture input on a predetermined spatial region corresponding to the touch screen; and a spatial convergence module adjusting at least one of the touch coordinate and the gesture coordinate based on a reference coordinate for a predetermined space by determining if the touch input and the gesture input are consecutive inputs based on the touch coordinate and the gesture coordinate.

The touch input module may include: a touch sensing module outputting a touch sensing signal for a touched point when there is the touch input; and a touch processing module outputting the touch coordinate based on the touch sensing signal.

The touch sensing module may include a touch sensor.

The gesture input module may include a gesture sensing module outputting a gesture sensing signal for gesture when there is the gesture input; and a gesture processing module outputting the gesture coordinate based on the gesture sensing signal.

The gesture sensing module obtains a gesture image when there is the gesture input.

The spatial convergence module may include a determination module determining if the touch input and the gesture input are consecutive inputs based on at least one of input time, an attribute value defining if there is spatial gesture support for a touch target, and the gesture coordinate when the touch coordinate and the gesture coordinate are inputted; and a resolution adjustment module adjusting the touch coordinate and the gesture coordinate corresponding to a boundary region between the touch screen plate region and the spatial region according to the reference coordinate when it is determined that the touch input and the gesture input are consecutive inputs.

The resolution adjustment module may estimate a spaced-apart distance on the plate region based on the gesture coordinate during the gesture input, and adjusts an input spatial ratio of the spatial region for a gesture movement range on the spatial region to correspond to a touch movement range on the plate region based on the estimated spaced-apart distance.

The user input device according to the present invention may further include a user input module recognizing a predetermined command corresponding to a user input on at least one region of the plate region and the spatial region.

A user input method according to another aspect of the present invention may include outputting a touch coordinate according to a touch input when there is the touch input on a touch screen region; outputting a gesture coordinate according to a gesture input when there is the gesture input on a predetermined spatial region corresponding to the touch screen; determining if the touch input and the gesture input are consecutive inputs during inputting the touch coordinate and gesture coordinate; and adjusting at least one of the touch coordinate and the gesture coordinate based on a reference coordinate for a space during the consecutive input.

The step of determining may include determining if the touch input and the gesture input are consecutive inputs based on at least one of input time, an attribute value defining if there is spatial gesture support for a touch target, and the gesture coordinate when the touch coordinate and the gesture coordinate are inputted.

The step of adjusting may include adjusting the touch coordinate and the gesture coordinate corresponding to a boundary region between the touch screen plate region and the spatial region according to the reference coordinate.

The step of adjusting may include estimating a spaced-apart distance on the plate region based on the gesture coordinate during the gesture input, and adjusting an input spatial ratio of the spatial region for a gesture movement range on the spatial region to correspond to a touch movement range on the plate region based on the estimated spaced-apart distance.

The present invention uses a 2D plate region and a 3D spatial region as one user input space to allow user touches and continuous movements of user's gesture which can be used as one user input gesture.

The present invention further increases not only accuracy of user's selection with touches but also degree of freedom in user's motions with spatial gestures to allow more accurate and natural user's gesture inputs.

The present invention further actively uses values for movement distances and movement speeds of a user's finger or an input device on the 2D touch region and the 3D spatial region, so that mapping user inputs such as strongly or weakly playing piano keys, fast or slowly spinning a top and the like is allowed with ordinary motions naturally.

### BRIEF DESCRIPTION OF THE DRAWINGS

FIG. 1 illustrates a schematic configuration of a user input device according to an embodiment of the present invention.

FIG. 2 illustrates resolution adjustment principle according to an embodiment of the present invention.

FIG. 3 illustrates spatial ratio adjustment principle according to an embodiment of the present invention.

FIG. 4 illustrates a user input method according to an embodiment of the present invention.

FIG. 5 is the first view illustrating a route tracking process according to an embodiment of the present invention.

FIG. 6 is the second view illustrating a route tracking process according to an embodiment of the present invention.

### DESCRIPTION OF THE EXEMPLARY EMBODIMENTS

A user input device and method thereof according to an embodiment of the present invention will be described below in more detail with reference to the accompanying drawings. It will be described based on parts necessary to understand better operations and functions of the present invention.

In descriptions of components of the invention, a different reference numeral may be assigned to the same component depending on the drawings, and the same reference numeral may be assigned to the same component in different drawings. However, neither of these means that the component has a different function depending on embodiments or that the component has the same function in different embodiments. Functions of each component may be determined based on descriptions of each component in the embodiment.

The present invention provides a method to recognize a touch input on a 2D plate and a gesture input on a 3D space as a user input in one continuous space.

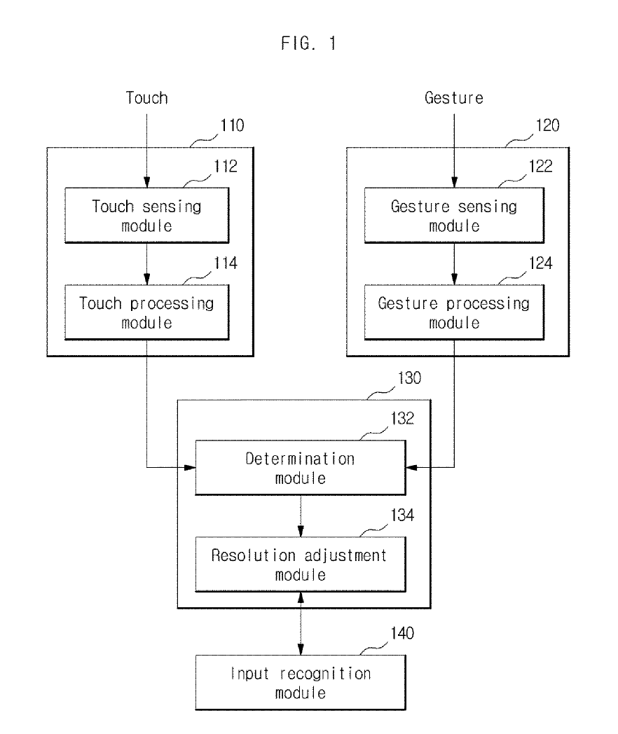

FIG. 1 illustrates a schematic configuration of a user input device according to an embodiment of the present invention.

Referring to FIG. 1, a user input device according to the present invention may include a touch input module 110, a gesture input module 120, a spatial convergence module 130, and an input recognition module 140.

In an embodiment, the user input device is a device including a touch screen, for example, a smart terminal, a smart pad, and a tabletop display device, etc. but it is not limited thereto.

Here, the touch input module 110 may include a touch sensing module 112 outputting a touch sensing signal for a touched point when there is the touch input and a touch processing module 114 outputting a touch coordinate based on the touch sensing signal.

The touch sensing module 112 outputs the touch sensing signal representing touch point or touch movement point corresponding to a touch input or a touch gesture input when a user or an input device touch inputs or touch gesture inputs on the touch screen.

The touch sensing module 112 may include a touch sensor which can detect touch point but it is not limited thereto.

Here, the touch processing module 114 may output a touch coordinate corresponding to the touch point or the touch movement point based on signal level of the touch sensing signal during the touch sensing signal input.

The touch processing module 114 may estimate a touch coordinate based on a predetermined sensing algorithm for a 2D plate region to output the estimated touch coordinate.

The gesture input module 120 may include a gesture sensing module 122 outputting a gesture sensing signal for gesture when there is the gesture input; and a gesture processing module 124 outputting a gesture coordinate based on the gesture sensing signal.

The gesture sensing module 122 may output the gesture sensing signal by tracking user's gestures (motions) on a 3D spatial region.

Here, the gesture sensing module 122 may include at least one of a camera and an infrared ray sensor but it is not limited thereto.

The gesture sensing module 122 tracks gestures from the moment a user's finger or an electronic pen is taken off from the touch screen and outputs the gesture sensing signal based on the tracked result.

The gesture processing module 124 may estimate a gesture coordinate corresponding to the user's gesture based on the gesture sensing signal. The gesture processing module 124 may estimate a gesture coordinate for the 3D spatial region using a predetermined sensing algorithm.

The spatial convergence module 130 may include a determination module 132 determining if the touch input and the gesture input are consecutive inputs based on input time when the touch coordinate and the gesture coordinate are inputted; and a resolution adjustment module 134 adjusting the touch coordinate and the gesture coordinate corresponding to a boundary region between the touch screen plate region and the spatial region according to the reference coordinate when it is determined that the touch input and the gesture input are consecutive inputs

Here, the determination module 132 can determine if the touch input and the gesture input are consecutive inputs based on input time difference between input time of the touch coordinate and input time of the gesture coordinate, an attribute value defining if there is spatial gesture support for a touch target, the touch coordinate and the gesture coordinate and the like.

Here, the resolution adjustment module 134 can adjust the touch coordinate and the gesture coordinate according to the reference coordinate predetermined to perform the touch input and the gesture input continuously in the boundary region of 2D and 3D spaces and to let movements of a cursor or contents, which correspond to the touch and gesture inputs on the touch screen and gesture space, be natural while tracking gestures (motions) of a user's finger or an input device on the boundary region where gesture inputs are performed on the spatial region after touch input by the user's finger and the input device on the touch screen.

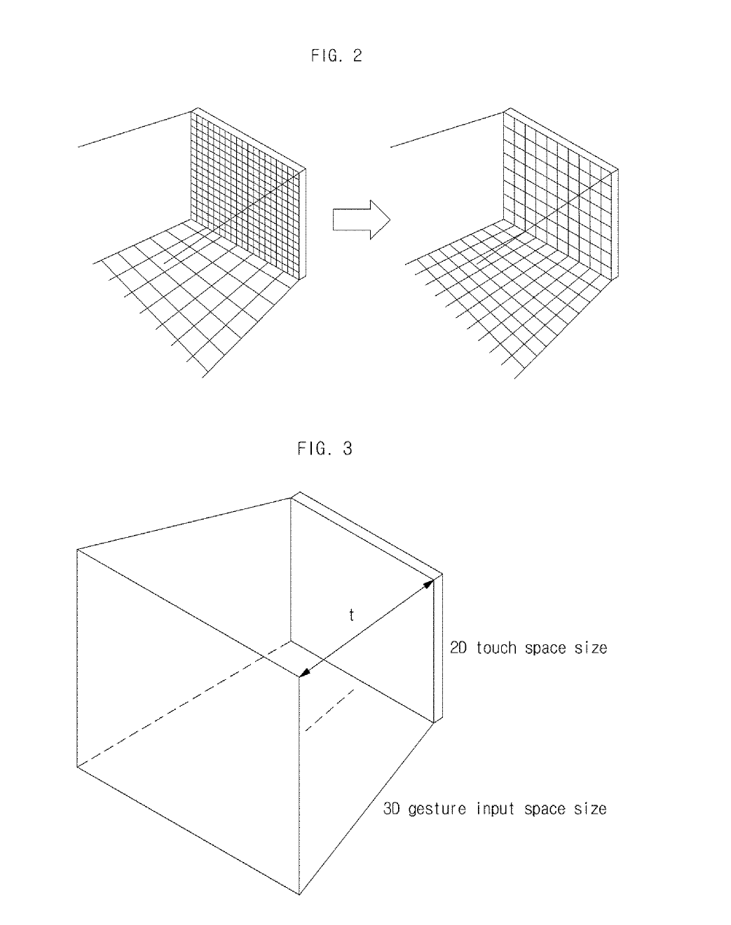

FIG. 2 illustrates resolution adjustment principle according to an embodiment of the present invention.

As shown in FIG. 2, coordinates recognized in the 2D touch region and the 3D gesture space cause difference in resolution due to sensing technology and data characteristics. Thus, difference in resolutions of the 2D touch region and the 3D gesture space in the left side may be adjusted for the 2D touch region and the 3D gesture space to have the same resolution as in the right side.

The resolution adjustment module 134 of the present invention connects smoothly discontinuous tracking coordinate movements which can be caused at the boundary region of two different regions through the resolution adjustment.

In an application to represent the cursor movement from the 2D touch region to the 3D gesture input space in a continuous linear movement, resolutions can be adjusted to connect the linear movement smoothly at the boundary of two regions.

The resolution adjustment module 134 may estimate a spaced-apart distance on the plate region based on the gesture coordinate during the gesture input and adjust an input spatial ratio of the spatial region for a gesture movement range on the spatial region to correspond to a touch movement range on the plate region based on the estimated spaced-apart distance.

FIG. 3 illustrates spatial ratio adjustment principle according to an embodiment of the present invention.

As shown in FIG. 3, since degree of user touch input motion on the 2D touch region and degree of user gesture input motion on the 3D spatial region are different each other, a movement range within the 2D touch plate and a movement range of physical movement with the 3D space are not identical based on the absolute threshold which thus causes unnaturalness of user input.

Therefore, the size of the 2D touch region may be enlarged to the size of 3D gesture input space which is a distance of t away from the 2D touch region. The resolution adjustment module 134 of the present invention may adjust a recognition spatial ratio to reflect image of user's motion to be enlarged naturally to the input recognition space by employing a method for enlarging the user's input space which expands the spatial input region in a trapezoidal shape as the touch region becomes away on the basis of the input region on the touch region.

The input recognition module 140 may recognize a predetermined command corresponding to the user input on at least one region of the 2D plate region and the 3D spatial region

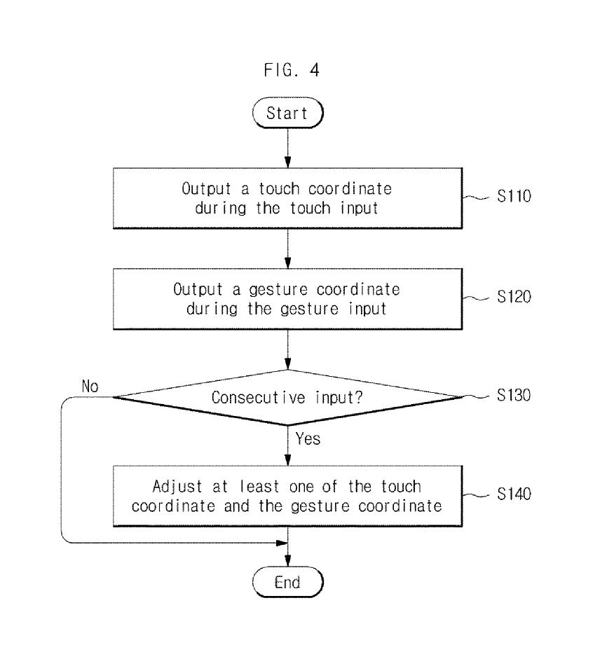

FIG. 4 illustrates a user input method according to an embodiment of the present invention.

Referring to FIG. 4, the user input device according to the present invention outputs a touch coordinate when there is a touch input on a touch screen region in S110 and outputs a gesture coordinate when there is a gesture input on a predetermined spatial region corresponding to the touch screen in S120.

The touch sensing module 112 of the user input device may output a touch sensing signal representing a touched point or touch movement point which corresponds to touch input or touch gesture input when a user or an input device touch inputs or touch gesture inputs on the touch screen.

Here, the touch processing module 114 may output a touch coordinate, which corresponds to the touch point or the touch movement point, based on the touch sensing signal during inputting the touch sensing signal.

The gesture sensing module 122 of the user input device may output a gesture sensing signal by tracking user's gestures (motions) on the 3D spatial region.

Here, the gesture sensing module 122 tracks gestures from the moment a user's finger or an electronic pen is taken off from the touch screen and outputs the gesture sensing signal based on the tracked result.

The gesture processing module 124 may estimate a gesture coordinate corresponding to the user's gesture based on the gesture sensing signal. The gesture processing module 124 may estimate a gesture coordinate for the 3D spatial region using a predetermined sensing algorithm.

The user input device may determine if the touch input and the gesture input are consecutive inputs when the touch coordinate and the gesture coordinate are inputted in S130.

Here, the determination module 132 of the user input device determines if the touch input and the gesture input are consecutive inputs based on input time difference between input time of the touch coordinate and input time of the gesture coordinate, an attribute value defining if there is spatial gesture support for a touch target, the touch coordinate and the gesture coordinate and the like.

The user input device may adjust at least one of the touch coordinate and the gesture coordinate based on a reference coordinate for a predetermined space during the consecutive input as the determined result in S140.

Here, the resolution adjustment module 134 of the user input device may adjust the touch coordinate and the gesture coordinate according to the reference coordinate predetermined to perform the touch input and the gesture input continuously in the boundary region of 2D and 3D spaces and to let movement of a cursor or contents, which correspond to the touch and gesture inputs on the touch screen and gesture space, be natural while tracking gestures of a user's finger or an input device on the boundary region where gesture inputs are performed on the spatial region after touch input by the user's finger and the input device on the touch screen.

The resolution adjustment module 134 of the user input device may also estimate a spaced-apart distance on the plate region based on the gesture coordinate during the gesture input and adjust an input spatial ratio of the spatial region for a gesture movement range on the spatial region to correspond to a touch movement range on the plate region based on the estimated spaced-apart distance.

The user input device according to the present invention may allow tracking movement route of multi- or single point of input means such as fingertip or electronic pen.

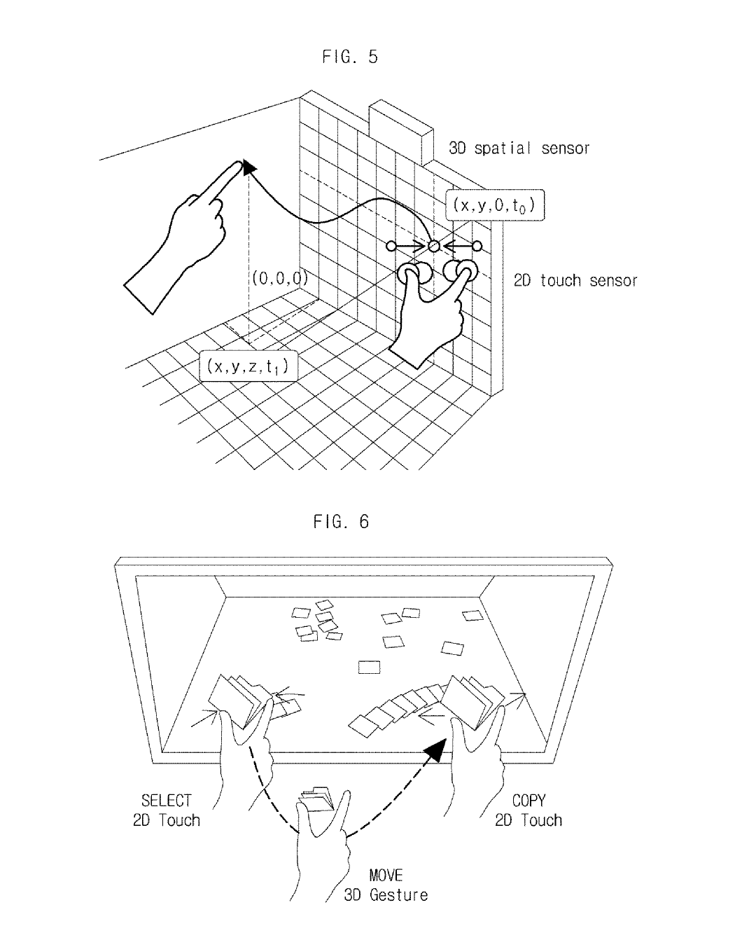

FIG. 5 is the first view illustrating a route tracking process according to an embodiment of the present invention.

Referring to FIG. 5, the user input device according to the present invention allows sensing of multi- or single-point coordinate which is able to move the touch plate and the 3D space smoothly like one region by comprising a touch input unit, a gesture input unit, a space convergence unit.

FIG. 6 is the second view illustrating a route tracking process according to an embodiment of the present invention.

Referring to FIG. 6, it is noted that the touch input unit, the gesture input unit, the space convergence unit, and an input recognition unit can be applied to a user input system for 3D GUI environment. Commands from holding action in a touch plate, moving in a space and performing action back in the touch plate may be performed.

Meanwhile, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

The exemplary embodiments of the present invention described hereinabove are only an example of the present invention and may be variously modified and altered by those skilled in the art to which the present invention pertains without departing from essential features of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall with the scope of the present invention.

### DESCRIPTION OF REFERENCE NUMERALS

110: touch input module
120: gesture input module
130: spatial convergence module
140: input recognition module

What is claimed is:

1. A user input device comprising:
a touch input module outputting a touch coordinate according to a touch input when there is the touch input on a touch screen region;
a gesture input module outputting a gesture coordinate according to a gesture input when there is the gesture input on a predetermined spatial region corresponding to the touch screen; and
a spatial convergence module adjusting at least one of the touch coordinate and the gesture coordinate based on a reference coordinate for a predetermined space by determining if the touch input and the gesture input are consecutive inputs based on the touch coordinate and the gesture coordinate.

2. The user input device of claim 1, wherein the touch input module comprises: a touch sensing module outputting a touch sensing signal for a touched point when there is the touch input; and a touch processing module outputting the touch coordinate based on the touch sensing signal.

3. The user input device of claim 2, wherein the touch sensing module comprises a touch sensor.

4. The user input device of claim 1, wherein the gesture input module comprises a gesture sensing module outputting a gesture sensing signal for gesture when there is the gesture input; and a gesture processing module outputting the gesture coordinate based on the gesture sensing signal.

5. The user input device of claim 4, wherein the gesture sensing module obtains a gesture image when there is the gesture input.

6. The user input device of claim 1, wherein the spatial convergence module comprises a determination module determining if the touch input and the gesture input are consecutive inputs based on at least one of input time, an attribute value defining if there is spatial gesture support for a touch target, and the gesture coordinate when the touch coordinate and the gesture coordinate are inputted; and a resolution adjustment module adjusting the touch coordinate and the gesture coordinate corresponding to a boundary region between the touch screen plate region and the spatial region according to the reference coordinate when it is determined that the touch input and the gesture input are consecutive inputs.

7. The user input device of claim 6, wherein the resolution adjustment module estimates a spaced-apart distance on the plate region based on the gesture coordinate during the gesture input, and adjusts an input spatial ratio of the spatial region for a gesture movement range on the spatial region to correspond to a touch movement range on the plate region based on the estimated spaced-apart distance.

8. The user input device of claim 1, further comprising a user input module recognizing a predetermined command corresponding to a user input on at least one region of the plate region and the spatial region.

9. A user input method comprising:
outputting a touch coordinate according to a touch input when there is the touch input on a touch screen region;
outputting a gesture coordinate according to a gesture input when there is the gesture input on a predetermined spatial region corresponding to the touch screen;
determining if the touch input and the gesture input are consecutive inputs during inputting the touch coordinate and gesture coordinate; and
adjusting at least one of the touch coordinate and the gesture coordinate based on a reference coordinate for a space during the consecutive input.

10. The user input method of claim 9, wherein the step of determining comprises determining if the touch input and the gesture input are consecutive inputs based on at least one of input time, an attribute value defining if there is spatial gesture support for a touch target, and the gesture coordinate when the touch coordinate and the gesture coordinate are inputted.

11. The user input method of claim 9, wherein the step of adjusting comprises adjusting the touch coordinate and the gesture coordinate corresponding to a boundary region between the touch screen plate region and the spatial region according to the reference coordinate.

12. The user input method of claim 9, wherein the step of adjusting comprises estimating a spaced-apart distance on the plate region based on the gesture coordinate during the gesture input, and adjusting an input spatial ratio of the spatial region for a gesture movement range on the spatial region to correspond to a touch movement range on the plate region based on the estimated spaced-apart distance.
